(19) United States
(12) Patent Application Publication
(10) Pub. No.: US 2021/0106154 A1
(43) Pub. Date: Apr. 15, 2021

(54) BED COVER CLASP SYSTEM

(71) Applicant: Marlie Incorporated, Fort Lauderdale, FL (US)

(72) Inventors: David Gimes, Fort Lauderdale, FL (US); Colin Campbell, Fort Lauderdale, FL (US)

(73) Assignee: Marlie Incorporated, Fort Lauderdale, FL (US)

(21) Appl. No.: 17/068,120

(22) Filed: Oct. 12, 2020

Related U.S. Application Data
(60) Provisional application No. 62/913,459, filed on Oct. 10, 2019.

(51) Int. Cl. A47G 9/04; A01K 1/035

(52) U.S. Cl. CPC A47G 9/04; A01K 1/0353

(57) ABSTRACT

A bed cover clasp system (20) can include a bed (10) having a top surface (5) and corners (4), a bed cover (6) having a shape substantially matching the shape of the top surface of the bed and including a number of corners (7), a strap (24) attached to each of the recessed corners (22) of the bed, and a strap (8) attached to each of the corners of the bed cover. The system further includes a first clasp mechanism portion (26 and/or 28) attached to each strap (24) attached the recessed corners of the bed and a second clasp mechanism portion (9) attached to the corners of the bed cover where the first clasp mechanism and second clasp mechanism portions cause the bed cover to evenly cover the top surface of the bed when each of the first clasp mechanism portions correspondingly mate with the second clasp mechanism portions.

### CROSS-REFERENCE TO RELATED APPLICATIONS

This This application claims priority under 35 U.S.C. Section 119(e) to U.S. Provisional Application No. 62/913,459 filed on Oct. 10, 2019, the entire content of which is incorporated herein by reference thereto.

### FIELD OF THE DISCLOSURE

The present disclosure generally relates to systems and methods in the field of cover retention systems, and more particularly relates to a bed cover clasp system.

### BACKGROUND

Bed covers and bed sheets are difficult to retain in place on a bed. A user sitting or resting on the bed or bed cover will more than likely cause the cover or sheet to crumple and become unsightly. At minimum, the bed sheet or bed cover will likely become uncentered and displaced from an orderly appearance.

### BRIEF DESCRIPTION OF DRAWINGS

FIG. 1 illustrates a pet bed according to one embodiment of the disclosure;

FIG. 2 illustrates a pet bed and cover or topper combination in accordance with one embodiment embodiment of the disclosure;

FIG. 3 illustrates a bottom view of a cover or topper in accordance with one embodiment of the disclosure;

FIG. 4 illustrates a close-up bottom view of a corner of the cover or topper of FIG. 3 in accordance with an embodiment;

FIG. 5 illustrates a top view of the cover or topper of FIGS. 2-4 in accordance with an embodiment of the disclosure;

FIG. 6 illustrates a close up top view of a corner of the cover or topper of FIGS. 2-5 in accordance with an embodiment of the disclosure;

FIG. 7 illustrates a close up view of a corner of the bed and of a corner of the cover or topper of FIGS. 2-6 in accordance with an embodiment of the disclosure;

FIG. 8 illustrates a close up view of a corner of the bed of FIGS. 2-7 in accordance with an embodiment of the disclosure; and

FIG. 9 illustrates another close up view of a corner of the bed and of a corner of the cover or topper of FIGS. 2-7 in accordance with an embodiment of the disclosure.

### DETAILED DESCRIPTION

### Glossary of Terms

Cover or Topper—is a sheet or other cover made of any material that would cover a top surface of a bed such as a pet bed.

A clasp is an attachment mechanism that can be selectively opened and biased to automatically close.

A carabiner is a type of clasp that typically includes a spring loaded locking mechanism. In some instances the carabiner is made of hardened steel and includes a “KN” rating indicating a weight or strength rating equivalent to an amount of weight capacity in pounds that the carabiner can hold.

A clasp mechanism portion can be any portion on either mating ends where the clasp mechanism portion can include just a ring on one side that mates with a clasp on the other side; or the clasp mechanism portion can be a ring attached to a clasp on one side that mates with a ring on the other side; or the clasp mechanism portion can be a ring attached to a clasp on one side that attaches to a another clasp attached to another ring on the other side. In some embodiments, the clasp mechanism portion can be just a clasp or carabiner that mates with a ring on the other side; or the clasp mechanism portion can be a clasp or carabine that mates with another clasp or carabiner on the other side.

Described herein is a bed cover clasp system that can be embodied in numerous forms to accommodate various beds. As bed products come in various forms, the shape of the cover clasp system can be modified in accordance with the embodiments to best suit one or more of the intended products. It will be apparent, however, to one skilled in the art that embodiments herein may be practiced without some or all of these specific details. In other instances, well known steps and/or structures have not been described in order to not unnecessarily obscure the embodiments of the system.

Unless otherwise indicated, all numbers expressing quantities, conditions, and the like in the instant disclosure and claims are to be understood as modified in all instances by the term “about.” The term “about” refers, for example, to numerical values covering a range of plus or minus 10% of the numerical value. The modifier “about” used in combination with a quantity is inclusive of the stated value.

In this specification and the claims that follow, singular forms such as “a”, “an”, and “the” include plural forms unless the content clearly dictates otherwise.

In some embodiments, the system can include a bed having a top surface and at least three recessed corners, a bed cover having a shape substantially matching the shape of the top surface of the bed and including a number of corners matching a number of corners of the bed, a strap attached to each of the recessed corners of the bed, and a strap attached to each of a number of corners of the bed cover matching the number of recessed corners of the bed. The system can further include at least a first clasp mechanism portion attached to each strap attached to each of the recessed corners of the bed and a second clasp mechanism portion attached to each of the corners of the bed cover where the first clasp mechanism portion and the second clasp mechanism are arranged and configured to cause the bed cover to evenly cover the top surface of the bed when each of the first clasp mechanism portions correspondingly mate with each of the second clasp mechanism portions.

In some embodiments, the strap attached to each of the recessed corners of the bed and the strap attached to each of the corners of the bed cover are made from elastic. In some embodiments, the strap attached to each of the recessed corners of the bed are elastic and the strap attached to each of the corners of the bed cover are non-elastic. In some embodiments, the strap attached to each of the recessed corners of the bed are non-elastic and the strap attached to each of the corners of the bed cover are elastic.

In some embodiments the at least first clasp mechanism portion includes a ring coupled to a clasp and the second clasp mechanism portion includes a ring coupled to a clasp. In some embodiments, the at least first clasp mechanism portion includes a ring and the second clasp mechanism portion includes a ring coupled to a clasp. In yet other embodiments, the at least first clasp mechanism portion includes a ring coupled to a clasp and the second clasp mechanism portion comprises a clasp. In some embodiments, the at least first clasp mechanism portion includes a ring coupled to a carabiner and the second clasp mechanism portion comprises a ring. In some embodiments, the at least first clasp mechanism portion includes a ring and the second clasp mechanism portion includes a ring coupled to a carabiner.

In some embodiments, the strap attached to each of the recessed corners of the bed is attached with stitching and the strap attached to each of the corners of the bed cover is attached by stitching.

In some embodiments, the bed is a pet bed having bumpers on the sides of the bed. In other embodiments, the bed is any size and any shape having corners.

In some embodiments, the one or more of the a straps attached to each of the recessed corners of the bed or the straps attached to each of the corners of the bed cover are made of hook and loop fasteners or Velcro.

In some embodiments, the at least first clasp mechanism portion and the second clasp mechanism portion each include a hinge configured to allow release of the bed cover from the bed by unhinging either hinge.

In some embodiments, a bed cover clasp system can include a bed cover having a shape substantially matching a shape of a top surface of a bed and including a number of corners matching a number of corners of the bed, a strap attached to each of a number of corners of the bed cover matching a number of recessed corners of the bed, and a clasp mechanism portion attached to each of the corners of the bed cover where the clasp mechanism portion is configured to cause the bed cover to evenly cover the top surface of the bed when each of the clasp mechanism portions correspondingly mate with each of a second clasp mechanism portions attached to the recessed corners of the bed. In some embodiments, the clasp mechanism portion attached to each of the corners of the bed cover is a ring. In some embodiments, the clasp mechanism portion attached to each of the corners of the bed cover is a ring and a clasp. In some embodiments, the clasp mechanism portion attached to each of the corners of the bed cover is a ring configured to selectively attach to the second clasp mechanism portions, wherein the second clasp mechanism portions is a ring coupled to a clasp. In yet other embodiments, the clasp mechanism portion attached to each of the corners of the bed cover includes a carabiner attached to each strap attached to the corners of the bed cover and configured to selectively attach to the second clasp mechanism portions.

In some embodiments, a bed cover clasp system includes a bed cover having a substantially rectangular shape substantially matching a shape of a top surface of a pet bed and including four corners matching four corners of the pet bed, an elastic strap attached to each of the four corners of the bed cover, and a clasp mechanism portion in the form of a ring attached to each of the corners of the bed cover via the elastic strap where the clasp mechanism portion is configured to cause the bed cover to evenly cover the top surface of the bed when each of the rings correspondingly mate with each of a second clasp mechanism portion attached to a strap at each of a recessed area of the four corners of the pet bed. In some embodiments, the bed cover is machine washable.

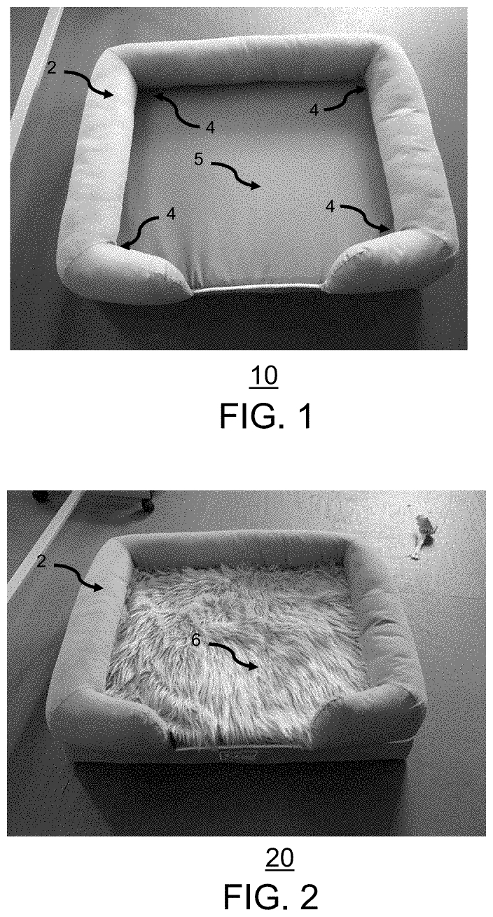

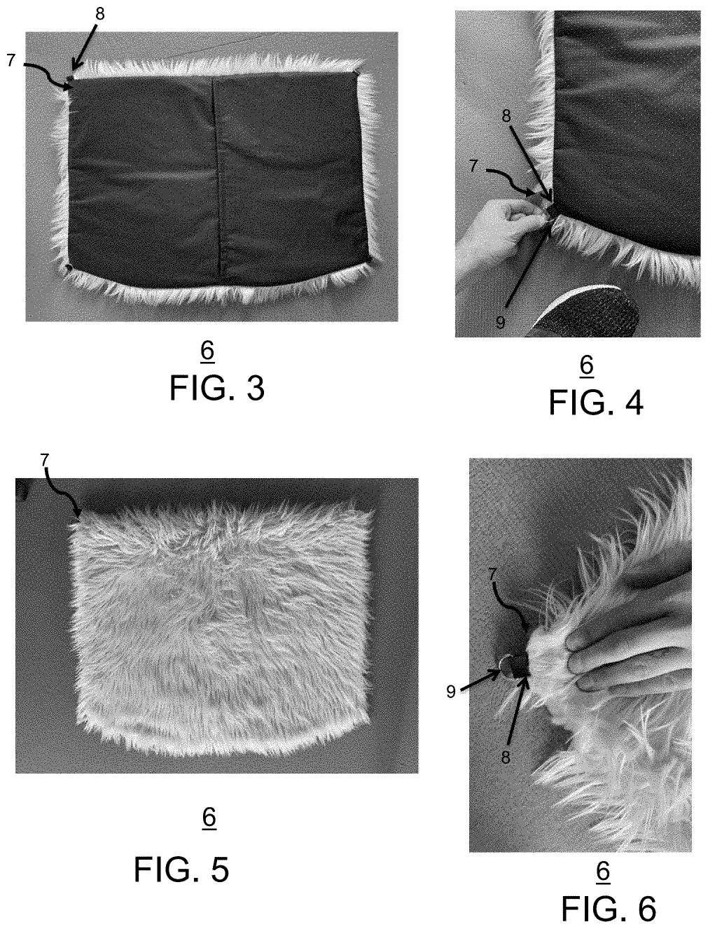

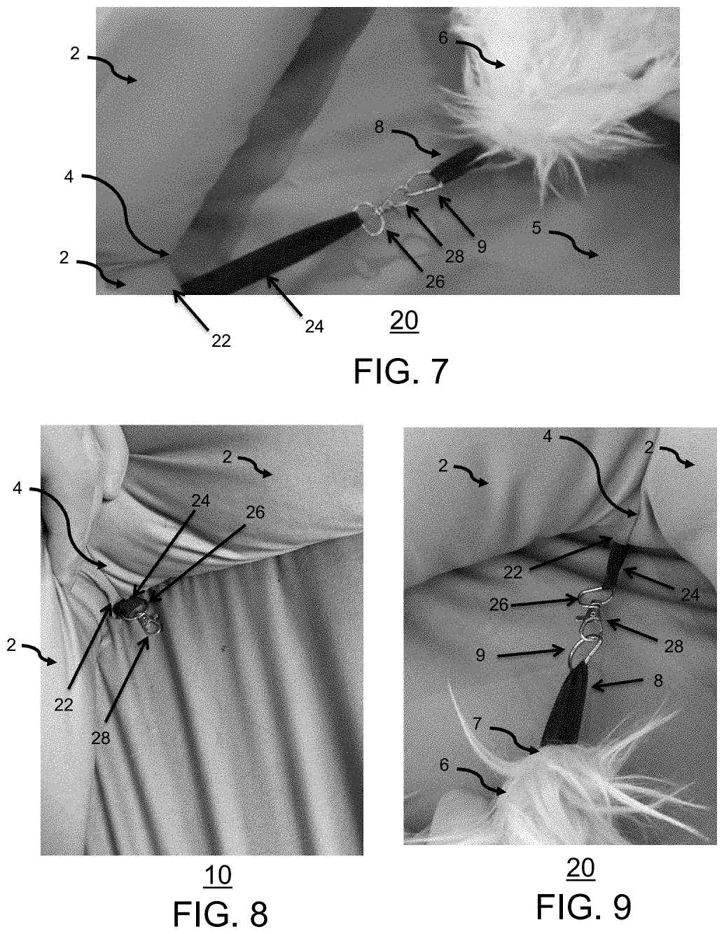

In some embodiments and referring to FIGS. 1-9, a bed cover clasp system 20 as shown in FIG. 2 includes a bed cover 6 having a substantially rectangular shape substantially matching a shape of a top surface of a pet bed 10 and including four corners 7 (as shown in FIGS. 3 and 5) matching four corners 4 (as shown in FIG. 1) of the pet bed 10, an elastic strap 8 attached to each of the four corners of the bed cover 6, and a clasp mechanism portion in the form of a ring 9 attached to each of the corners 7 of the bed cover 6 via the elastic strap 8 where the clasp mechanism portion is configured to cause the bed cover to evenly cover the top surface of the bed as shown in FIG. 2 when each of the rings 9 correspondingly mate with each of a second clasp mechanism portion (26 and/or 28) attached to a strap 24 at each of a recessed area 4 of the four corners of the pet bed 10. In some embodiments, the bed cover is machine washable.

In some embodiments and referring again to FIGS. 1-9, the system 20 can include a bed 10 having a top surface 5 and at least three recessed corners 4, a bed cover 6 having a shape substantially matching the shape of the top surface of the bed and including a number of corners 7 matching a number of corners 4 of the bed 10, a strap 24 attached to each of the recessed corners 22 of the bed 10, and a strap 8 attached to each of a number of corners 7 of the bed cover 6 matching the number of recessed corners 22 of the bed 10. The system 20 can further include at least a first clasp mechanism portion (26 and/or 28) attached to each strap 24 attached to each of the recessed corners 22 of the bed 10 and a second clasp mechanism portion 9 attached to each of the corners 7 of the bed cover 6 where the first clasp mechanism portion and the second clasp mechanism are arranged and configured to cause the bed cover to evenly cover the top surface 5 of the bed 10 when each of the first clasp mechanism portions correspondingly mate with each of the second clasp mechanism portions.

In some embodiments, the strap 24 attached to each of the recessed corners 22 of the bed 10 and the strap 8 attached to each of the corners 7 of the bed cover 6 are made from elastic. The straps 8 and 24 can be made of different materials and they do not necessarily need to be made of elastic material, but most embodiments will likely include at least one side on either the bed or the bed cover side that will have elastic properties. In some embodiments, the strap 24 attached to each of the recessed corners of the bed are elastic and the strap 8 attached to each of the corners of the bed cover are non-elastic. In some embodiments, the strap 24 attached to each of the recessed corners of the bed 10 are non-elastic and the strap 8 attached to each of the corners 7 of the bed cover 6 are elastic.

In some embodiments, the at least first clasp mechanism portion (26 and/or 28) includes a ring 26 coupled to a clasp 28 and the second clasp mechanism portion includes a ring 9 coupled to a clasp (not shown, but can be similar or the same as clasp 28). In some embodiments, the at least first clasp mechanism portion includes a ring 26 and the second clasp mechanism portion includes a ring 9 coupled to a clasp (not shown, but can be similar or the same as clasp 28). In yet other embodiments, the at least first clasp mechanism portion includes a ring 26 coupled to a clasp 28 and the second clasp mechanism portion comprises a clasp (not shown, but can be similar or the same as clasp 28). In some embodiments, the at least first clasp mechanism portion includes a ring 26 coupled to a carabiner (a particular type of clasp) and the second clasp mechanism portion comprises a ring 9. In some embodiments, the at least first clasp mechanism portion includes a ring 26 and the second clasp mechanism portion includes a ring 9 coupled to a carabiner.

In some embodiments, the strap attached to each of the recessed corners of the bed is attached with stitching and the strap attached to each of the corners of the bed cover is attached by stitching. The embodiments are not limited to attaching the straps to either the bed corners or the cover corners with stitching. Other mechanisms such as buttons, rivets, adhesive or other attachment mechanism can be used to provide a firm attachment between the straps and the corresponding anchoring portion of either the bed or bed cover as the case may be.

In some embodiments, the bed is a pet bed having bumpers 2 on the sides of the bed as shown in FIGS. 1-2 and 7-9. In other embodiments, the bed is any size and any shape having corners.

In some embodiments, the one or more of the straps 24 attached to each of the recessed corners 22 of the bed 10 or the straps 8 attached to each of the corners 7 of the bed cover 6 are made of hook and loop fasteners or Velcro. If a ring is used along with the straps (either 24 or 8), then ideally a loop is formed out of the strap to retain the corresponding ring. In some embodiments, the strap can include some Velcro and the ring can be inserted before the Velcro strap is closed. If a carabiner is used instead of a ring, the strap can be made of any material that includes a loop at its unattached end and the carabiner can be selectively attached to the loop of the strap end.

In some embodiments, the at least first clasp mechanism portion and the second clasp mechanism portion each include a hinge configured to allow release of the bed cover from the bed by unhinging either hinge.

In some embodiments, a bed cover clasp system 20 can include a bed cover 6 having a shape substantially matching a shape of a top surface 5 of a bed 10 and including a number of corners 7 matching a number of corners 4 of the bed, a strap 8 attached to each of a number of corners 7 of the bed cover 6 matching a number of recessed corners 22 of the bed 10, and a clasp mechanism portion (9, in some embodiment) attached to each of the corners 7 of the bed cover 6 where the clasp mechanism portion is configured to cause the bed cover to evenly cover the top surface 5 of the bed 10 when each of the clasp mechanism portions correspondingly mate with each of a second clasp mechanism portions (26 or 28) attached to the recessed corners 22 of the bed 10. In some embodiments, the clasp mechanism portion attached to each of the corners 7 of the bed cover 6 is just a ring 9. In some embodiments, the clasp mechanism portion attached to each of the corners 7 of the bed cover 6 is a ring 6 and a clasp (not shown, but can be similar to clasp 28). In some embodiments, the clasp mechanism portion attached to each of the corners 7 of the bed cover 6 is a ring (possibly like a carabiner) configured to selectively attach to the second clasp mechanism portions (coupled to the bed 10), wherein the second clasp mechanism portions is a ring 26 coupled to a clasp 28. In yet other embodiments, the clasp mechanism portion attached to each of the corners 7 of the bed cover 6 includes a carabiner attached to each strap 8 attached to the corners 7 of the bed cover 6 and configured to selectively attach to the second clasp mechanism portions.

It will be appreciated by those skilled in the art that the present invention can be embodied in other specific forms without departing from the spirit or essential characteristics thereof. The presently disclosed embodiments are therefore considered in all respects to be illustrative and not restricted. Modifications and variations are possible in light of the above teachings or may be acquired from practicing of the disclosure, without departing from the breadth or scope.

1. A bed cover clasp system, comprising:
a bed having a top surface and at least three recessed corners;
a bed cover having a shape substantially matching the shape of the top surface of the bed and including a number of corners matching a number of corners of the bed;
a strap attached to each of the recessed corners of the bed;
a strap attached to each of a number of corners of the bed cover matching the number of recessed corners of the bed;
at least a first clasp mechanism portion attached to each strap attached to each of the recessed corners of the bed;
a second clasp mechanism portion attached to each of the corners of the bed cover; and
wherein the first clasp mechanism portion and the second clasp mechanism are arranged and configured to cause the bed cover to evenly cover the top surface of the bed when each of the first clasp mechanism portions correspondingly mate with each of the second clasp mechanism portions.

2. The bed cover clasp system of claim 1, wherein the strap attached to each of the recessed corners of the bed and the strap attached to each of the corners of the bed cover are made from elastic.

3. The bed cover clasp system of claim 1, wherein the strap attached to each of the recessed corners of the bed are elastic and the strap attached to each of the corners of the bed cover are non-elastic.

4. The bed cover clasp system of claim 1, wherein the strap attached to each of the recessed corners of the bed are non-elastic and the strap attached to each of the corners of the bed cover are elastic.

5. The bed cover clasp system of claim 1, wherein the at least first clasp mechanism portion comprises a ring coupled to a clasp and the second clasp mechanism portion comprises a ring coupled to a clasp.

6. The bed cover clasp system of claim 1, wherein the at least first clasp mechanism portion comprises a ring and the second clasp mechanism portion comprises a ring coupled to a clasp.

7. The bed cover clasp system of claim 1, wherein the at least first clasp mechanism portion comprises a ring coupled to a clasp and the second clasp mechanism portion comprises a clasp.

8. The bed cover clasp system of claim 1, wherein the at least first clasp mechanism portion comprises a ring coupled to a carabiner and the second clasp mechanism portion comprises a ring.

9. The bed cover clasp system of claim 1, wherein the at least first clasp mechanism portion comprises a ring and the second clasp mechanism portion comprises a ring coupled to a carabiner.

10. The bed cover clasp system of claim 1, wherein the strap attached to each of the recessed corners of the bed is attached with stitching and the strap attached to each of the corners of the bed cover is attached by stitching.

11. The bed cover clasp system of claim 1, wherein the bed is a pet bed having bumpers on at least three sides of the bed.

12. The bed cover clasp system of claim 1, wherein one or more of the a straps attached to each of the recessed corners of the bed or of the straps to each of the corners of the bed cover are made of hook and loop fasteners.

13. The bed cover clasp system of claim 1, wherein the at least first clasp mechanism portion and the second clasp mechanism portion each include a hinge configured to allow release of the bed cover from the bed by unhinging either hinge.

14. A bed cover clasp system, comprising:
a bed cover having a shape substantially matching a shape of a top surface of a bed and including a number of corners matching a number of corners of the bed;
a strap attached to each of a number of corners of the bed cover matching a number of recessed corners of the bed;
a clasp mechanism portion attached to each of the corners of the bed cover; and
wherein the clasp mechanism portion is configured to cause the bed cover to evenly cover the top surface of the bed when each of the clasp mechanism portions correspondingly mate with each of a second clasp mechanism portions attached to the recessed corners of the bed.

15. The bed cover clasp system of claim 14, wherein the clasp mechanism portion attached to each of the corners of the bed cover comprises a ring.

16. The bed cover clasp system of claim 14, wherein the clasp mechanism portion attached to each of the corners of the bed cover comprises a ring and a clasp.

17. The bed cover clasp system of claim 14, wherein the clasp mechanism portion attached to each of the corners of the bed cover comprises a ring configured to selectively attach to the second clasp mechanism portions, wherein the second clasp mechanism portions comprises a ring coupled to a clasp.

18. The bed cover clasp system of claim 14, wherein the clasp mechanism portion attached to each of the corners of the bed cover comprises a carabiner attached to each strap attached to the corners of the bed cover and configured to selectively attach to the second clasp mechanism portions.

19. A bed cover clasp system, comprising:
a bed cover having a substantially rectangular shape substantially matching a shape of a top surface of a pet bed and including four corners matching four corners of the pet bed;
an elastic strap attached to each of the four corners of the bed cover;
a clasp mechanism portion in the form of a ring attached to each of the corners of the bed cover via the elastic strap; and
wherein the clasp mechanism portion is configured to cause the bed cover to evenly cover the top surface of the bed when each of the rings correspondingly mate with each of a second clasp mechanism portion attached to a strap at each of a recessed area of the four corners of the pet bed.

20. The bed cover clasp system of claim 19, wherein the bed cover is machine washable.
